(19) United States
(12) Patent Application Publication
(10) Pub. No.: US 2010/0188337 A1
(43) Pub. Date: Jul. 29, 2010

(54) COMPUTER MOUSE PROVIDING A TOUCHLESS INPUT INTERFACE

(75) Inventor: Geoffry A. Westphal, Evanston, IL (US)

Correspondence Address: GREENBERG TRAURIG, LLP, 77 WEST WACKER DRIVE, SUITE 3100, CHICAGO, IL, 60601-1732, US

(73) Assignee: W.W. GRAINGER, INC., Lake Forest, IL (US)

(21) Appl. No.: 12/361,072

(22) Filed: Jan. 28, 2009

(51) Int. Cl. G09G 5/08

(52) U.S. Cl. 345/166

(57) ABSTRACT

A computer input device, such as a mouse, has a processing circuit, a memory having instructions for controlling operations of the processing circuit, a surface movement sensor in communication with the processing circuit providing to the processing circuit first signals indicative of sensed movement of the computer input device upon a surface, and one or more touchless sensor subsystems in communication with the processing circuit providing to the processing circuit second signals indicative of sensed surface movements relative to the computer input device occurring in spaced proximity to the computer input device. A transmission circuit under control of the processing circuit issues transmissions to a computer representative of the first and second signals to cause regions or locations on a computer display screen to be pointed to, to cause information which is represented on the computer display screen to be moved and/or selected, to cause locations on the computer display screen to be designated, etc.

### BACKGROUND

The following relates generally to input devices for computers and, more particularly, relates to a computer mouse that provides a touchless input interface.

In the art input devices for computers, such as a computer mouse, are well known. By way of example, U.S. Pat. No. 5,157,381 describes that a computer mouse is typically utilized by a computer user to point to regions or locations on a display screen, to select/move information which is represented on the display screen, to designate locations on the display screen, etc. Thus, the possible uses of a computer mouse are well known in relationship to its pointing and selection capabilities.

As further described in U.S. Pat. No. 5,157,381, many designs for computer mouses or mice exist and, among the most popular designs, are two button computer mice and three button computer mice. The two button computer mouse is a simple design in which the two buttons are provided on the front edge of the mouse so that the user's index and middle finger can be easily disposed atop the two buttons. The three button computer mouse design generally enhances the flexibility of the two button computer mouse design by providing a button intermediate the aforementioned two buttons such that a user may utilize the index finger, middle finger, and ring finger in order to control the selection of these three buttons. As will be appreciated, a three button computer mouse provides greater flexibility for button function assignment as compared to a two button computer mouse.

By way of still further example, U.S. Pat. No. 7,209,116 discloses that it is also conventional to provide a scroll wheel to a computer mouse, for example, in lieu of the third mouse button described above. As will be appreciated by those of ordinary skill in the art, the scroll wheel may be interacted with by a user to, for example, effect a scrolling operation on the display screen. It is also know to provide the scroll wheel with the ability to be depressed to provide still further scroll or selection functionality.

Yet further, U.S. Pat. No. 7,168,047 describes a mouse for controlling movements on a display screen. The mouse includes a housing that is gripped by a user during manipulation of the mouse and a sensor is provided to detect the presence, but not movement, of a user's hand or portions thereof located outside of and in close proximity to a predetermined portion of the housing. The proximity signals produced by the sensor are used to control functionalities of the mouse, as for example, switching between a cursor control mode and a scroll/pan control mode of the mouse.

For the sake of brevity in the descriptions that follows, the disclosures in these referenced publications are incorporated herein by reference in their entirety.

### SUMMARY

The following generally discloses a computer input device that provides a touchless input interface. Generally, the computer input device comprises a housing in which is carried a processing circuit; a memory having instructions for controlling operations of the processing circuit; a surface movement sensor in communication with the processing circuit providing to the processing circuit first signals indicative of sensed movement of the computer input device upon a surface; and one or more touchless sensor subsystems in communication with the processing circuit providing to the processing circuit second signals indicative of sensed surface movements relative to the computer input device occurring in spaced proximity to the computer input device. A transmission circuit under control of the processing circuit issues transmissions to a computer representative of the first and second signals to cause regions or locations on a computer display screen to be pointed to, to cause information which is represented on the computer display screen to be moved and/or selected, to cause locations on the computer display screen to be designated, etc.

A better appreciation of the objects, advantages, features, properties, and relationships of the disclosed computer mouse will be obtained from the following detailed description and accompanying drawings which set forth illustrative embodiments which are indicative of the various ways in which the principles described hereinafter may be employed.

### BRIEF DESCRIPTION OF THE DRAWINGS

For use in better understanding of the exemplary computer input device described hereinafter reference may be had to the following drawings in which:

FIG. 1 illustrates an isometric view of an exemplary computer mouse constructed in accordance with the present invention; and

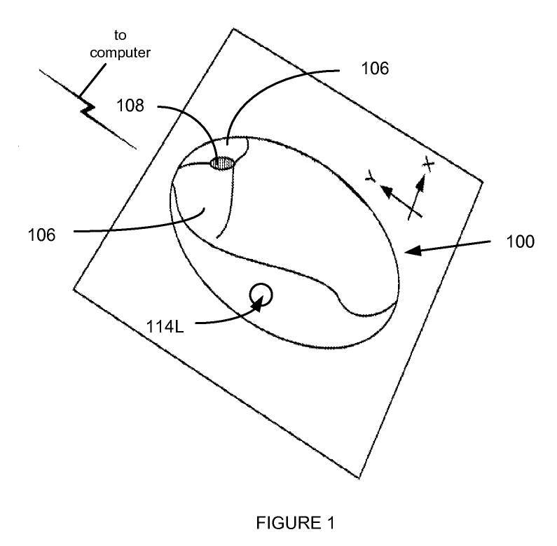

FIG. 2 illustrates a block diagram of exemplary components of the exemplary computer mouse of FIG. 1.

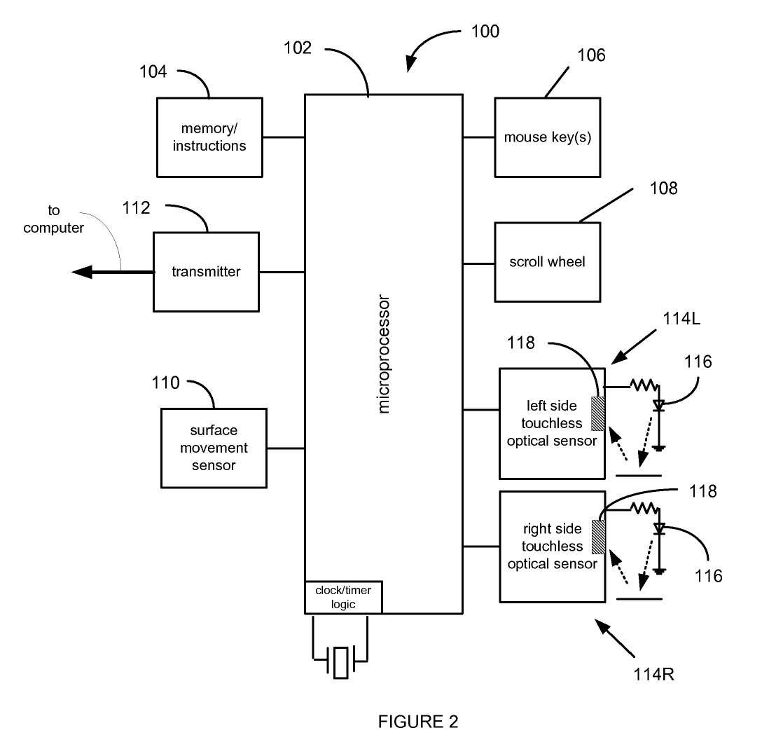

### DETAILED DESCRIPTION

With reference to the figures, the following discloses a computer input device 100, or mouse, having a touchless user interface. To this end, the computer input device 100 may include, as needed for a particular application, a processor 102 coupled to a memory 104, a mouse button or key matrix 106, a scroll wheel 108, a surface movement sensor 110, and a transmission or transceiver circuit 112. To control the operation of the computer input device 100, the memory 104 may include executable instructions that are intended to be executed by the processor 102. In this manner, the processor 102 may be programmed to control the various electronic components within the computer input device 100, e.g., to monitor a power supply (not shown), to cause the transmission of signals via the transmission circuit 112 to a computer in response to user interactions with the computer input device 100, i.e., sensed events, etc. The memory 104 may also function to store setup data and parameters as necessary. The memory 304 may be comprised of any type of readable media, such as ROM, RAM, SRAM, FLASH, EEPROM, or the like. In addition, the memory 104 may take the form of a chip, a hard disk, a magnetic disk, and/or an optical disk.

As noted above, the computer input device 100 is adapted to be responsive to events, such as a sensed user interaction with the scroll wheel 108, mouse buttons 106, movement of the computer input device 100 over a surface as sensed by sensor 110 (e.g., a trackball, optical sensor, or the like), etc. In response to such events appropriate instructions within the memory 104 may be executed. For example, when a function button 106 is activated on the computer input device 100, the computer input device 100 may execute appropriate instructions to cause the transmission circuit 112 to transmit a signal indicative of a sensed event to a computer. As will be appreciated by those of skill in the art, the computer input device 100 may transmit signals to the computer via a wired or wireless (e.g., IR or RF) connection.

For providing a touchless user interface by which events may be provided to the computer input device 100, the computer input device 100 may include left and/or right touchless sensor subsystems 114L/114R which are to be used to sense movements of surface, e.g., a user's hand or fingers, proximate to the left and/or rights sides of the computer input device 100. By way of example only, each of the touchless sensor subsystems 114L/114R can be implemented by using one or more commercially available integrated, optical sensor packages, e.g., an Agilent ADNS-2030 sensor package which includes a digital signal processor (“DSP”), memory, and self-contained programming with which to process incoming image frames. Thus, in keeping with this example, when an integrated sensor subsystem is enabled by the processor 102, the optical sensor subsystem 114L/114R functions to emit a light, e.g., via a LED 116, for the purpose of illuminating a surface (e.g., a finger) positioned proximate to the computer input device 100, to capture sequential images of surface features (frames) via a lens and a light sensor 118, to thereby perform a mathematical analysis of the differences between successive frames in order to determine direction, magnitude, and/or speed of movement of the surface relative to the computer input device 100, which surface movement information is reported back to processor 200 for onward transmission to the computer via transmitter 112. As will be apparent, the surface movement information reported back by the sensor subsystems 114L/114R can be representative of finger gestures, such as finger taps, fingers swipes, etc. proximate to one or both of the left and right sides of the computer input device 100, that, in turn, may be used, when provided to a computer, to cause regions or locations on a computer display screen to be pointed to, to cause information which is represented on the computer display screen to be moved and/or selected, to cause locations on the computer display screen to be designated, etc. Furthermore, while described in the context of an integrated, optical, touchless sensor subsystem, it will be appreciated that other touchless subsystems may be employed for this purpose.

As will be appreciated from the foregoing, because any gesture that is performed proximate to the computer input device 100 is capable of being sensed and reported to a computer, the computer can be programmed to map any sensed gesture(s) to any action on the computer. By way of example only, and not intended to be limiting, the driver and software of the computer can be programmed to recognize signals received from the computer input device 100 that indicative of a simultaneous double tap gesture being performed on both sides of the computer input device 100 and thereby cause an activation of the gesture based input mode of the computer input device 100. Similarly, the driver and software of the computer can be programmed to recognize signals received from the computer input device 100 indicative of a double swipe down gesture performed on at least one side of the computer input and thereby cause a scroll up or a page up operation to be performed on the computer display. Yet further, the driver and software of the computer can be programmed to recognize signals received from the computer input device 100 that are indicative of a tapping gesture being performed on the right side of the computer input device 100 with a surface being sensed as being anchored on the left side of the computer input device 100 and thereby cause a cursor displayed on a display screen to move in the right direction, to cause a display to pan right, etc. It is to be understood that these gesture inputs and corresponding operations are provided by way of example only and are not intended to be limiting. Rather, those of ordinary skill in the art will understand that signals received from the computer input device 100 indicative of gestures performed on one or more sides of the computer input device can be mapped within the computer to any type of action to, for example, cause regions or locations on a computer display screen to be pointed to, to cause information which is represented on the computer display screen to be moved and/or selected, to cause locations on the computer display screen to be designated, to change operating modes associated with the computer device, etc.

While various concepts have been described in detail, it will be appreciated by those skilled in the art that various modifications and alternatives to those concepts could be developed in light of the overall teachings of the disclosure. For example, because the computer input device is adapted to be receive touchless, gesture commands, the computer input device need not include one or more of the scroll wheel 108 or the mouse keys 106. Furthermore, while described in the context of an integrated sensor package, it will be appreciated that the light energy that is to be received by the described light energy sensor need not be provided by the sensor subsystem itself but could be provided from an alternative source of light energy which light energy source may be external to the computer input device or resident on the computer input device, such as a generated, sweeping light beam, without limitation. Still further, while a light sensing system was described as being used by the sensor subsystems 114L/114R, it will be appreciated that any form of energy that is reflective, such as sound, may be similarly used to determine direction, magnitude, and/or speed of movement of a surface relative to the computer input device. Yet further, it is to be appreciated that the sensor subsystems 114L/114R may determine direction, magnitude, and/or speed of movement of a surface relative to the computer input device by sensing energy that is emitted from the surface itself, e.g., heat. As such, the particular embodiments that have been described are meant to be illustrative only and not limiting as to the scope of the invention which is to be given the full breadth of the appended claims and any equivalents thereof.

What is claimed is:

1. A computer input device, comprising:
a housing in which is carried a processing circuit; a memory having instructions for controlling operations of the processing circuit; a surface movement sensor in communication with the processing circuit providing to the processing circuit first signals indicative of sensed movement of the computer input device upon a surface; a first touchless sensor subsystem in communication with the processing circuit providing to the processing circuit second signals indicative of sensed surface movements relative to the computer input device occurring in spaced proximity to the computer input device; and a transmission circuit under control of the processing circuit for issuing transmission to a computer representative of the first and second signals.

2. The computer input device as recited in claim 1, comprising a second touchless sensor subsystem in communication with the processing circuit providing to the processing circuit third signals indicative of sensed surface movements relative to the computer input device occurring in spaced proximity to the computer input device and the transmission circuit under control of the processing circuit further issues transmissions to a computer representative of the third signals.

3. The computer input device as recited in claim 2, wherein the first and second touchless sensor subsystems are disposed on opposites sides of the housing of the computer input device.

4. The computer input device as recited in claim 3, wherein the first and second touchless sensor subsystems are optical sensing subsystems.

5. The computer input device as recited in claim 4, wherein light is generated for used by the first and second touchless sensor subsystems from a source of light energy external to the first and second touchless sensor subsystems.

6. The computer input device as recited in claim 3, wherein the first and second touchless sensor subsystems are thermal sensing subsystems.

7. The computer input device as recited in claim 3, wherein the first and second touchless sensor subsystems are sound sensing subsystems.

8. The computer input device as recited in claim 4, comprising one or more buttons carried on the housing and providing to the processing circuit fourth signals indicative of a sensed interaction with the one or more buttons and the transmission circuit under control of the processing circuit further issues transmissions to a computer representative of the fourth signals.

9. The computer input device as recited in claim 8, comprising a scroll wheel carried on the housing and providing to the processing circuit fifth signals indicative of a sensed interaction with the scroll wheel and the transmission circuit under control of the processing circuit further issues transmissions to a computer representative of the fifth signals.

10. The computer input device as recited in claim 1, wherein the transmission circuit transmits signals to a computer using an RF protocol.

11. The computer input device as recited in claim 1, wherein the transmission circuit transmits signals to a computer using an IR protocol.

12. A computer input device, comprising:
a housing in which is carried a processing circuit; a memory having instructions for controlling operations of the processing circuit; first and second touchless sensor subsystems in communication with the processing circuit providing to the processing circuit signals indicative of sensed surface movements relative to the computer input device occurring in spaced proximity to the computer input device; and a transmission circuit under control of the processing circuit for issuing transmission to a computer representative of the signals.

13. The computer input device as recited in claim 12, wherein the first and second touchless sensor subsystems are disposed on opposites sides of the housing of the computer input device.

14. The computer input device as recited in claim 13, wherein the first and second touchless sensor subsystems are optical sensing subsystems.

15. The computer input device as recited in claim 14, wherein light is generated for used by the first and second touchless sensor subsystems from a source of light energy external to the first and second touchless sensor subsystems.

16. The computer input device as recited in claim 13, wherein the first and second touchless sensor subsystems are thermal sensing subsystems.

17. The computer input device as recited in claim 3, wherein the first and second touchless sensor subsystems are sound sensing subsystems.
